(19) United States
(12) Patent Application Publication
(10) Pub. No.: US 2025/0265831 A1
(43) Pub. Date: Aug. 21, 2025

(54) BUILDING VISION-LANGUAGE MODELS USING MASKED DISTILLATION FROM FOUNDATION MODELS

(71) Applicant: Adobe Inc., San Jose, CA (US)

(72) Inventors: Simon Jenni, Hägendorf (CH); Sepehr Sameni, Bern (CH); Kushal Kafle, Boston, MA (US); Hao Tan, San Jose, CA (US)

(21) Appl. No.: 18/443,808

(22) Filed: Feb. 16, 2024

(51) Int. Cl. G06V 10/82; G06F 40/40; G06V 10/26; G06V 10/764; G06V 10/774; G06V 10/776; G06V 20/70

(52) U.S. Cl. CPC G06V 10/82; G06F 40/40; G06V 10/26; G06V 10/764; G06V 10/774; G06V 10/776; G06V 20/70

(57) ABSTRACT

The present disclosure relates to systems, non-transitory computer-readable media, and methods for training and implementing a vision-language model using masked distillation and contrastive image-text training. In particular, in one or more embodiments, the disclosed systems generate, utilizing a vision encoder, an image embedding from a masked digital image comprising a digital image with one or more masked patches. In some embodiments, the disclosed systems generate, utilizing a text encoder, a text embedding from a masked text phrase. In one or more embodiments, the disclosed systems generate, utilizing the vision-language model from the image embedding and the text embedding, a predicted text reconstruction of the text description and a predicted image reconstruction of the digital image. In some embodiments, the disclosed systems modify parameters of the vision-language model according to a masked distillation loss between the predicted text reconstruction and a text reconstruction generated by a pretrained large language model.

### BACKGROUND

The emergence of vision-language models, exemplified by certain pioneering models, has been pivotal in integrating computer vision with natural language processing. Such models foster a unique symbiosis between visual and textual data for facilitating text-guided image retrieval systems, automated image captioning, and other breakthrough applications. Although systems employing existing vision-language models can perform such functions, these systems nevertheless exhibit a number of technical deficiencies regarding the quality of vision-language outputs they produce as well as the efficiency with which the vision-models are trained.

### SUMMARY

Embodiments of the present disclosure provide benefits and/or solve one or more of the foregoing or other problems in the art with systems, non-transitory computer-readable media, and methods for training and utilizing a new vision-language model architecture based on masked distillation and contrastive image-text pretraining. In some embodiments, the disclosed systems generate vision-language outputs using features learned via masked distillation from foundation models and/or via contrastive image-text pretraining between text and vision modalities of a vision-language model. For example, the disclosed systems leverage features of frozen foundation models (e.g., a vision foundation model and a large language model) to provide per-token target latent representations for a text encoder and a vision encoder of a vision-language model. In addition, in some embodiments, the disclosed systems use contrastive learning between the text encoder and the vision encoder to learn features in a unified embedding space for generating vision-language outputs.

### BRIEF DESCRIPTION OF THE DRAWINGS

The detailed description provides one or more embodiments with additional specificity and detail through the use of the accompanying drawings, as briefly described below.

FIG. 1 illustrates an example system environment in which a masked distillation system operates in accordance with one or more embodiments.

FIG. 2 illustrates an overview of training a vision-language model using masked distillation in accordance with one or more embodiments.

FIG. 3 illustrates an example diagram for training a vision-language model using masked distillation and image-text pretraining in accordance with one or more embodiments.

FIG. 4 illustrates an example diagram for implementing a vision-language model to generate vision-language outputs in accordance with one or more embodiments.

FIG. 5 illustrates an example table for classification performance in accordance with one or more embodiments.

FIGS. 6A-6C illustrate example tables for performance metrics of the masked distillation system in generating vision-language outputs in accordance with one or more embodiments.

FIG. 7 illustrates an example table of ablation study results in accordance with one or more embodiments.

FIG. 8 illustrates a schematic diagram of a masked distillation system in accordance with one or more embodiments.

FIG. 9 illustrates a flowchart of a series of acts for training a vision-language model using masked distillation and contrastive image-text training in accordance with one or more embodiments.

FIG. 10 illustrates a flowchart of a series of acts for training a vision-language model using feature projections from (or to) dimensionalities of foundational models in accordance with one or more embodiments.

FIG. 11 illustrates a flowchart of a series of acts for implementing a vision-language model to generate a vision-language output based on training from one or more foundational models in accordance with one or more embodiments.

FIG. 12 illustrates a block diagram of an example computing device for implementing one or more embodiments of the present disclosure.

### DETAILED DESCRIPTION

This disclosure describes one or more embodiments of a masked distillation system that trains and implements vision-language models using a combination of masked distillation and contrastive image-text pretraining. For example, the masked distillation system introduces a new vision-language architecture that distills features learned by foundational models into the encoders of the vision-language model. In some cases, the masked distillation system distills the foundational model features for both the vision encoder and the text encoder of the vision-language model by learning (linear) projections for each encoder from the unified embedding space of the vision language model to the respective dimensionalities of the foundational models. In addition, in one or more embodiments, the masked distillation system uses a masked distillation by inserting patch-wise masked training data (e.g., a masked digital image and masked text phrase) into the vision-language model and modifying model parameters using a masked distillation loss to encourage reconstruction of outputs generated by the foundational models.

As just mentioned, in some embodiments, the masked distillation system uses a contrastive learning approach to train a vision encoder and a text encoder of a vision-language model in a unified embedding space. For example, the masked distillation system uses a text encoder to generate a per-token text embedding from a (token of a) sample text phrase and compares the text embedding with an image embedding. Indeed, in some embodiments, the masked distillation system uses a vision encoder to generate a per-patch image embedding from a (patch of a) sample digital image to compare with the text embedding. In some cases, the masked distillation system utilizes a contrastive loss to compare and align the text embedding and the image embedding within a unified embedding space. In one or more embodiments, the masked distillation system further learns (linear) projections from the unified embedding space shared by the vision encoder and the text decoder into the respective dimensionalities of corresponding foundational models.

As just suggested, in some embodiments, the masked distillation system distills features from foundational models into a vision-language model. For instance, the masked distillation system uses a text-specific masked distillation to learn parameters for a text encoder from a text foundation model, such as a large language model. In addition, in certain embodiments, the masked distillation system uses a vision-specific masked distillation to learn parameters for a vision encoder from a vision foundation model. In some cases, the masked distillation system inputs masked data into the encoders of the vision-language model and uses distillation losses to encourage reconstruction (by corresponding decoders) of corresponding outputs generated by respective foundational models.

For example, the masked distillation system utilizes the vision encoder to generate a predicted image embedding from a masked digital image with one or more patches masked on input. As another example, the masked distillation system utilizes the text encoder to generate a predicted text embedding from a masked text phrase with one or more tokens (e.g., words) masked on input. In such cases, the masked distillation system utilizes a text-based masked distillation loss between the text encoder and its foundational large language model to encourage (or enforce) the text encoder to reconstruct a teacher text embedding generated by the large language model (from an unmasked version of the input). Likewise, in some cases, the masked distillation system uses a vision-based masked distillation loss between the vision encoder and its vision foundation model to encourage (or enforce) the vision encoder to reconstruct a teacher image embedding generated by the vision foundation model (from an unmasked version of the input). In one or more embodiments, the masked distillation system utilizes an overall training objective by combining a contrastive loss with a vision-based masked distillation loss and a text-based masked distillation loss.

In one or more embodiments, based on such training, the masked distillation system thus generates vision-language outputs, such as image classifications, generated image captions, image segmentations, and/or image and text retrieval. For instance, the masked distillation system generates or projects (using a text encoder of a vision-language model) a lookup table from a large language model trained on multilingual training data and utilizes the projected lookup table to generate vision-language outputs from input data. Accordingly, in some cases, the masked distillation system generates multilingual vision-language outputs without ever expressly inputting multilingual training data into the vision-language model.

As suggested above, many conventional vision-language systems exhibit a number of shortcomings or disadvantages, particularly in the quality or accuracy of generated vision-language outputs. For example, conventional systems often train vision-language models using a contrastive learning approach heavily reliant on alt-text data which is often marred by noise and is too generalized (e.g., lacks depth) for nuanced understanding of visual-text interplay. As a result, the models of existing systems frequently develop representations akin to a bag of words approach where the focus lies predominantly on identifying objects without adequately capturing compositional or relational context among the objects and/or the intricacies of their respective attributes. Such inaccuracies are even more pronounced in existing systems involving low-resource languages where quality paired training data is scarce. Consequently, existing systems often generate inaccurate vision-language outputs for underrepresented languages.

In addition to their inaccuracies, many existing systems are computationally inefficient. For example, a predominant trend among existing systems is to train vision-language models using extra supervision. Such extra supervision bogs down the training process, making it slower and more computationally expensive to carry out. In addition, some existing system use contrastive learning approaches to learn features across entire embedding spaces, which is also computationally expensive, especially for large embedding spaces associated with foundational models (e.g., vision foundation models and large language models). Along these lines, existing models that are capable of generating multilingual outputs generally require training on vast amounts of multilingual data across a diverse set of languages. Training over such large quantities of data consumes excessive amounts of computing resources, such as processing power and memory, that could otherwise be preserved with a more efficient system.

As suggested above, embodiments of the masked distillation system provide certain improvements or advantages over conventional vision-language systems. For example, embodiments of the masked distillation system improve the quality and accuracy of vision-language outputs by training and implementing a vision-language model using a combination of masked distillation and contrastive image-text pretraining. Specifically, the masked distillation system leverages the nuanced visual understanding of a vision foundation model and the detailed language knowledge of large language models by using respective masked distillation losses. Consequently, the masked distillation system generates high-quality vision-language outputs (e.g., classifications, segmentations, captions, or retrievals) with accurate reflections of composition and relational context among words and objects. As an added benefit of learning projections from features (in embedding spaces) of foundational models, such as a large language model, the masked distillation system inherits (much of) the multilingual capabilities of the foundational models. Accordingly, the masked distillation system can accurately generate multilingual vision-language outputs without ever training the vision-language model over multilingual data (e.g., training only on monolingual data).

In addition, certain embodiments of the masked distillation system provide improved computational efficiency over existing vision-language systems. For instance, compared to prior systems that expend excessive resources training vision-language models using extra supervision and/or feature training across whole embedding spaces, the masked distillation system trains much more quickly by learning linear projections from a shared embedding space of a vision-language model to respective dimensionalities (or embedding spaces) of corresponding foundational models. In addition, the masked distillation system projects a lookup table from a large language model trained on vast amounts of linguistic data across multiple languages to inherit or distill the multilingual capabilities of the large language model into the text encoder of a vision-language model (without ever training using multilingual data). By learning linear projections and inheriting multilingual functionality, the masked distillation system preserves computational resources, such as processing power and memory, compared to prior systems.

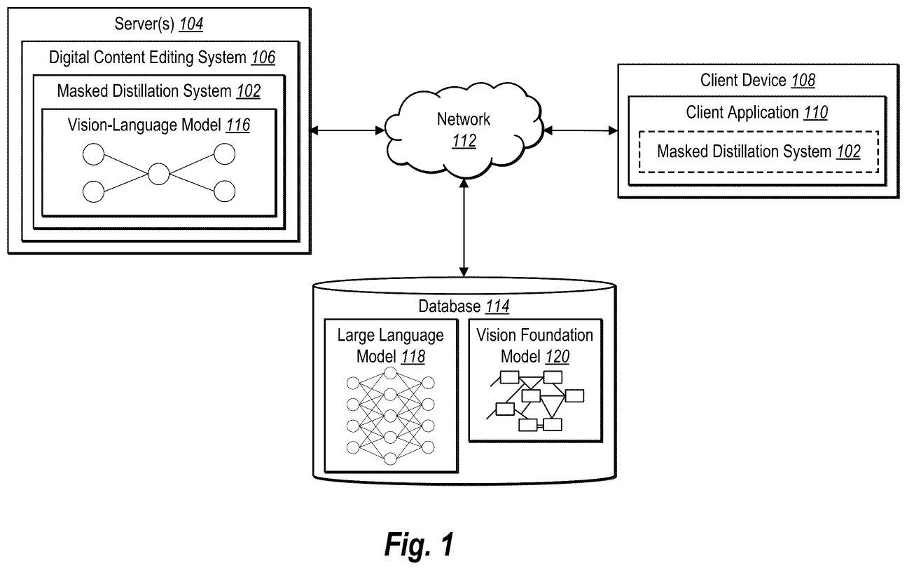

Additional detail regarding the masked distillation system will now be provided with reference to the figures. For example, FIG. 1 illustrates a schematic diagram of an example system environment for implementing a masked distillation system 102 in accordance with one or more embodiments. An overview of the masked distillation system 102 is described in relation to FIG. 1. Thereafter, a more detailed description of the components and processes of the masked distillation system 102 is provided in relation to the subsequent figures.

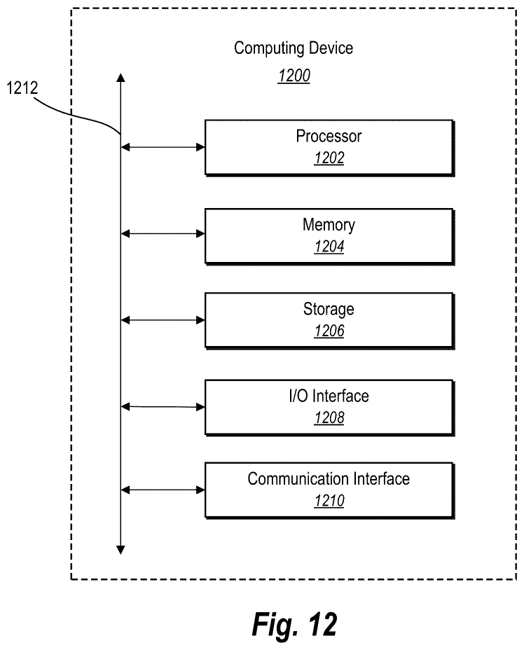

As shown, the environment includes server(s) 104, a client device 108, a database 114, and a network 112. Each of the components of the environment communicate via the network 112, and the network 112 is any suitable network over which computing devices communicate. Example networks are discussed in more detail below in relation to FIG. 12.

As mentioned, the environment includes a client device 108. The client device 108 is one of a variety of computing devices, including a smartphone, a tablet, a smart television, a desktop computer, a laptop computer, a virtual reality device, an augmented reality device, or another computing device as described in relation to FIG. 12. Although FIG. 1 illustrates a single instance of the client device 108, in some embodiments, the environment includes multiple different client devices, each associated with a different user (e.g., digital image editor). The client device 108 communicates with the server(s) 104 and/or the digital content editing system 106 via network 112. For example, the client device 108 receives user interactions to generate a vision-language output using a vision-language model and provides information to server(s) 104 for utilizing a vision-language model to generate the vision-language output.

As shown in FIG. 1, the client device 108 includes a client application 110. In particular, the client application 110 is a web application, a native application installed on the client device 108 (e.g., a mobile application or a desktop application), or a cloud-based application where all or part of the functionality is performed by the server(s) 104. The client application 110 presents or displays information to a user, including vision-language interfaces for generating, editing, modifying, or visualizing vision-language outputs. In some embodiments, the client application 110 executes, houses, or operates all or a portion of the masked distillation system 102.

As also illustrated in FIG. 1, the environment includes the server(s) 104. The server(s) 104 generates, tracks, stores, processes, receives, and transmits electronic data, such as training data, vision-language outputs, and vision-language inputs. For example, the server(s) 104 receives data from the client device 108 in the form of interaction data requesting generation of a vision-language output. In response, the server(s) 104 provides data to the client device 108 in the form of a generated vision-language output displayable at the client device 108.

In some embodiments, the server(s) 104 communicates with the client device 108 to transmit and/or receive data via the network 112. In some embodiments, the server(s) 104 comprises a distributed server where the server(s) 104 includes a number of server devices distributed across the network 112 and located in different physical locations. The server(s) 104 comprise a content server, an application server, a communication server, a web-hosting server, a multidimensional server, or a machine learning server.

As further shown in FIG. 1, the server(s) 104 also includes the masked distillation system 102 as part of a digital content editing system 106. For example, in one or more implementations, the digital content editing system 106 stores, generates, modifies, edits, enhances, provides, distributes, and/or shares digital content, such as digital images, digital text, or digital videos. For example, the digital content editing system 106 provides digital content for editing or other forms of digital processing. In some implementations, the digital content editing system 106 provides digital content to particular digital profiles associated with client devices (e.g., the client device 108).

In one or more embodiments, the server(s) 104 includes all, or a portion of, the masked distillation system 102. For example, the masked distillation system 102 operates on the server(s) 104 to train and implement a vision-language model 116. In some embodiments, the client device 108 includes all or part of the masked distillation system 102. For example, the client device 108 generates, obtains (e.g., downloads), or uses one or more aspects of the masked distillation system 102, such as the vision-language model 116, from the server(s) 104. Indeed, in some implementations, as illustrated in FIG. 1, the masked distillation system 102 is located in whole or in part of the client device 108 (e.g., as part of the client application 110). For example, the masked distillation system 102 includes a web hosting application that allows the client device 108 to interact with the server(s) 104. To illustrate, in one or more implementations, the client device 108 accesses a web page supported and/or hosted by the server(s) 104.

As shown in FIG. 1, the environment includes a database 114. For example, the server(s) 104 communicate with the database 114 to access training data and/or foundational models for training the vision-language model 116. In some embodiments, the database 114 houses or stores foundational models for distilling parameters to the vision-language model 116. Such foundational models include a large language model 118 for distilling text-based features and a vision foundation model 120 for distilling vision-based features. In one or more embodiments, the vision foundation model 120 is a DINOv2 model as described by Maxime Oquab et al. in LEARNING ROBUST VISUAL FEATURES WITHOUT SUPERVISION, arXiv abs/2304.07193 (2023), or a SAM-H/16 model as described by Alexander Kirillov et al. in SEGMENT ANYTHING, arXiv abs/2304.02643 (2023). In some cases, the database 114 is housed, managed, or maintained by the server(s) 104. In other cases, the database 114 is a third-party database accessible via the network 112 but not managed by the server(s) 104.

In one or more embodiments, the client device 108 and the server(s) 104 work together to implement the masked distillation system 102. For example, in some embodiments, the server(s) 104 train one or more neural networks (e.g., a text encoder and/or a vision encoder of a vision-language model) and provide the one or more neural networks to the client device 108 for implementation. In some embodiments, the server(s) 104 trains one or more neural networks together with the client device 108.

Although FIG. 1 illustrates a particular arrangement of the environment, in some embodiments, the environment has a different arrangement of components and/or may have a different number or set of components altogether. For instance, as mentioned, the masked distillation system 102 is implemented by (e.g., located entirely or in part on) the client device 108. In addition, in one or more embodiments, the client device 108 communicates directly with the masked distillation system 102, bypassing the network 112.

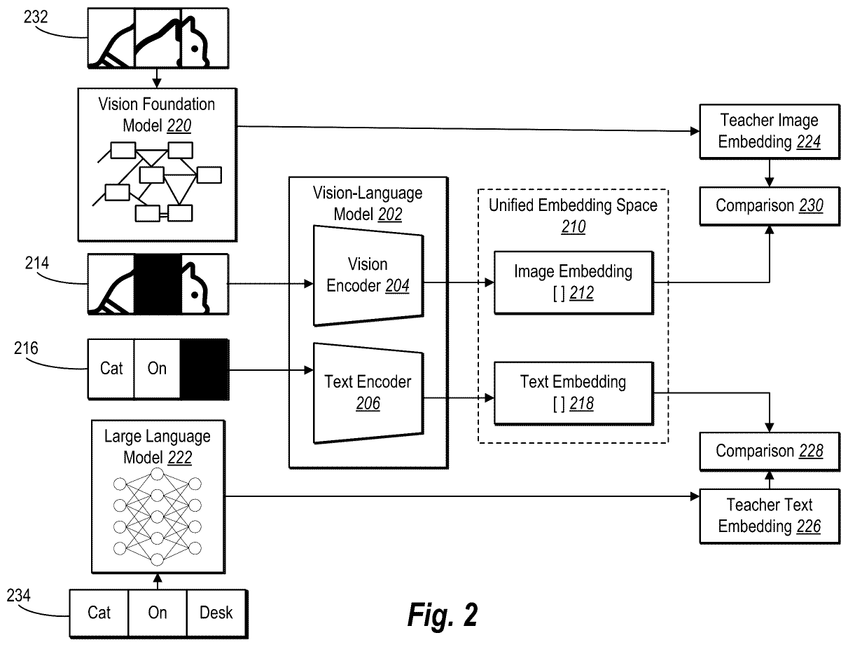

As mentioned, in one or more embodiments, the masked distillation system 102 trains or tunes a vision-language model. In particular, the masked distillation system 102 trains a vision-language model using a combination of masked distillation and image-text pretraining. FIG. 2 illustrates an example overview of training a vision-language model using masked distillation in accordance with one or more embodiments. Additional detail regarding the various acts and processes described in relation to FIG. 2 is provided thereafter with reference to subsequent figures.

As illustrated in FIG. 2, the masked distillation system 102 identifies or accesses a vision-language model 202. In some embodiments, the vision-language model 202 is a multimodal neural network that understands both text and image data. For example, the vision-language model 202 learns and utilizes a unified embedding space 210 for image features and text features to simultaneously understand images and text, as well as relationships and interplay between the two. In some cases, the vision-language model 202 includes various constituent networks, such as a text encoder 206 that extracts or encodes text embeddings in the unified embedding space 210 and a vision encoder 204 that extracts or encodes image embeddings in the unified embedding space 210. In some embodiments, the vision-language model 202 also includes a vision decoder for and a text decoder for mapping from the learned feature space of the vision-language model 202 to the respective feature speaces of the foundational models. In one or more embodiments, the vision-language model 202 is a transformer-based model based on the architecture described by Ashish Vaswani et al. in ATTENTION IS ALL YOU NEED, arXiv: 1706.03762 (2017).

Relatedly, in some embodiments, a neural network (e.g., a vision-language model, an encoder, or a decoder) includes or refers to a machine learning model that is trainable and/or tunable based on inputs to generate predictions, determine classifications, or approximate unknown functions. For example, a neural network includes a model of interconnected artificial neurons (e.g., organized in layers) that communicate and learn to approximate complex functions and generate outputs (e.g., digital images and/or digital text) based on a plurality of inputs provided to the neural network. In some cases, a neural network refers to an algorithm (or set of algorithms) that implements deep learning techniques to model high-level abstractions in data. For example, a neural network includes a deep neural network, a convolutional neural network, a recurrent neural network (e.g., an LSTM), a graph neural network, a transformer, or a generative neural network (e.g., a generative adversarial neural network or a diffusion neural network).

As illustrated in FIG. 2, as part of the training process, the masked distillation system 102 inputs a training pair into the vision-language model 202. The training pair includes a masked digital image 214 and a masked text phrase 216. Indeed, the masked distillation system 102 generates or accesses the masked digital image 214 as a digital image with one or more masked patches (compared to the unmasked digital image 232). For example, the masked digital image 214 includes, or is divided into, patches (e.g., in a grid of evenly sized patches), each depicting a respective portion of pixels of an overall image. In addition, the masked digital image 214 includes one or more patches that are masked by removal, blurring, obfuscation, or replacement with black (or gray or white or some other color of) pixels. In some cases, the masked distillation system 102 randomly masks (a certain proportion or percentage of) patches for the masked digital image 214.

Similarly, the masked distillation system 102 generates or accesses the masked text phrase 216 by masking portions or tokens (e.g., words or characters) of an input text phrase (e.g., the unmasked text phrase 234). For example, the masked text phrase 216 includes, or is divided into, tokens (e.g., words or characters). The masked text phrase 216 includes one or more tokens that are masked by removal, blurring, obfuscation, or replacement with blank space. In some cases, the masked distillation system 102 randomly masks (a certain proportion or percentage of) tokens for the masked text phrase 216.

As also illustrated in FIG. 2, the vision-language model 202 jointly processes the training pair (e.g., the masked digital image 214 and the masked text phrase 216) to generate embeddings in the unified embedding space 210. For instance, the vision-language model 202 generates an image embedding 212 and a text embedding 218. To elaborate, the vision-language model 202 processes the masked digital image 214 to generate the image embedding 212 and processes the masked text phrase 216 to generate the text embedding 218 within the unified embedding space 210. For example, the vision encoder 204 processes pixels (or patches) of the masked digital image 214 to encode or extract the image embedding 212 as a latent vector representation of the masked digital image 214 in the unified embedding space 210. Likewise, the text encoder 206 processes tokens of the masked text phrase 216 to encode or extract the text embedding 218 as a latent vector representation of the masked text phrase 216 in the unified embedding space 210.

To accurately generate the image embedding 212 and the text embedding 218 for reconstruction of the foundational-model outputs, the masked distillation system 102 distills features from foundational models into the vision-language model 202. For example, the masked distillation system 102 utilizes a masked distillation process to distill learned features of a vision foundation model 220 (e.g., the vision foundation model 120) into the vision encoder 204. Similarly, the masked distillation system 102 uses a masked distillation process to distill learned features of a large language model 222 (e.g., the large language model 118) into the text encoder 206. In some embodiments, masked distillation includes or refers to using a specialized distillation loss for distilling features learned by foundational teacher models into smaller student models using masked training inputs and a loss function that accounts for the masked inputs.

To elaborate, the masked distillation system 102 trains the vision encoder 204 via a comparison 230 in the form of a vision-based masked distillation loss to distill features of the vision foundation model 220 into the vision encoder 204 by encouraging or enforcing the vision encoder 204 to generate image embeddings that are reconstructions of teacher image embeddings generated by the vision foundation model 220 (e.g., from an unmasked digital image 232). For instance, the masked distillation system 102 performs the comparison 230 of the image embedding 212 with the teach image embedding 224 using a masked distillation loss. Based on the comparison 230, the masked distillation system 102 modifies parameters of the vision encoder 204 to adjust how the vision encoder 204 extracts image embeddings over multiple training iterations until the image embeddings (extracted by the vision encoder 204) satisfy a threshold measure of loss in relation to embeddings extracted by the vision foundation model 220 (or until images generated from the embeddings satisfy a threshold similarity or measure of loss in relation to images generated by the vision foundation model 220). In some cases, the vision foundation model 220 is a network with a large number of features learned by training over a vast array of training data for generating, reconstructing, or modifying digital images.

In a similar fashion, the masked distillation system 102 trains the text encoder 206 using a comparison 228 in the form of a text-based masked distillation loss to distill features of the large language model 222 into the text encoder 206 by encouraging or enforcing the text encoder 206 to generate text embeddings that are reconstructions of teacher text embeddings generated by the large language model 222 (e.g., from an unmasked text phrase 234). For instance, the masked distillation system 102 performs the comparison 228 of the text embedding 218 with the teacher text embedding 226 a masked distillation loss. Based on the comparison 228, the masked distillation system 102 modifies parameters of the text encoder 206 to adjust how the text encoder 206 extracts text embeddings over multiple training iterations until the text embeddings (extracted by the text encoder 206) satisfy a threshold measure of loss in relation to embeddings extracted by the large language model 222.

In some cases, the large language model 222 is a network with a large number of features learned by training over a vast array of training data for generating, reconstructing, or modifying text phrases. Indeed, in some embodiments, the large language model 222 is a neural network (e.g., a deep neural network) with many parameters trained on large quantities of data (e.g., unlabeled text) using a particular learning technique (e.g., self-supervised learning). In some cases, the large language model 222 includes many (e.g., hundreds of millions or billions of) parameters trained to generate model outputs (e.g., text phrases) learned from vast amounts (e.g., terabytes) of training data.

Based on the comparison 228 and the comparison 230, the masked distillation system 102 modifies parameters of the vision-language model 202 (e.g., the vision encoder 204 and the text encoder 206). Indeed, the masked distillation system 102 thus modifies parameters to encourage reconstruction of teacher outputs generated by corresponding foundational models (e.g., the vision foundation model 220 and the large language model 222).

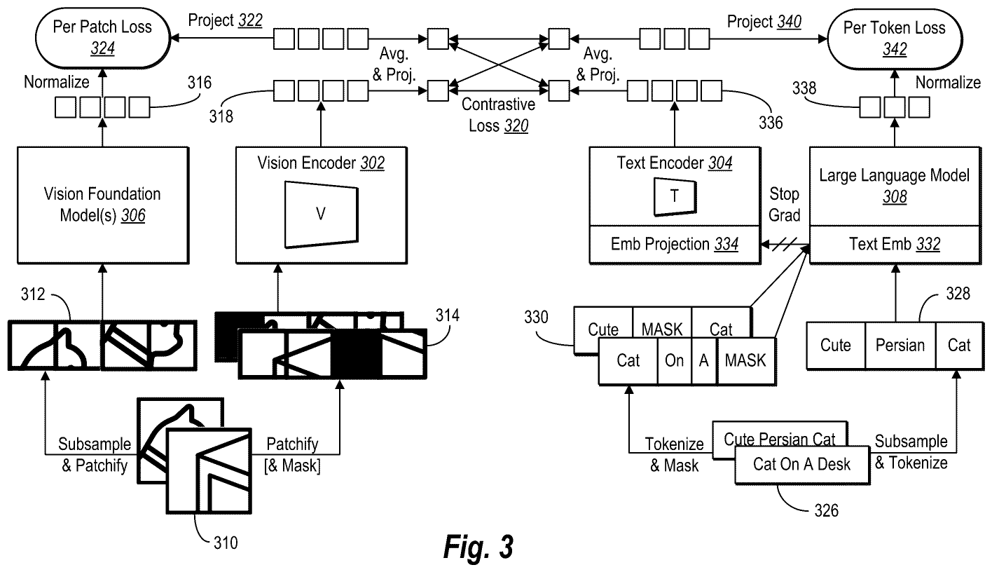

As noted above, in addition to using a masked distillation loss, the masked distillation system 102 utilizes an image-text pretraining to train a vision-language model. In particular, the masked distillation system 102 utilizes masked distillation together with image-text pretraining to learn parameters of a vision-language model. FIG. 3 illustrates an example diagram for training encoders of a vision-language model using masked distillation and contrastive image-text training in accordance with one or more embodiments.

As illustrated in FIG. 3, the masked distillation system 102 trains a vision encoder 302 and a text encoder 304 of a vision-language model. Specifically, the masked distillation system 102 learns a unified embedding space of text and images based on access to a paired dataset of images xᵢ and corresponding noisy captions yᵢ. The paired dataset of training data is represented as:

$$𝒟 = {\{ ( {x}_{i} , {y}_{i} ) \}}_{i = 1}^{N}$$

where [symbol] represents the dataset.

As part of the training process, the masked distillation system 102 trains the vision encoder 302 using learned features of a vision foundation model 306 (V_{teacher}) and trains the text encoder 304 using learned features of a large language model 308 (T_{teacher}). The vision encoder 302 and the text encoder 304 are each based on transformer architectures which encode an input into a sequence of feature vectors, such as:

$$V ( x ) ∈ {ℝ}^{{n}_{v} \times {d}_{v}}$$

where nᵥ is the number of tokens and dᵥ is the latent feature dimension.

To train the vision encoder 302, the masked distillation system 102 combines contrastive loss between paired data with a masked knowledge distillation objective in each modality (e.g., for images and text). As part of the training process, the masked distillation system 102 generates training data for the vision encoder 302, including a masked digital image 314. To generate the masked digital image 314, the masked distillation system 102 identifies and accesses a digital image 310, patchifies the digital image 310 by dividing the digital image 310 into patches, and masks one or more of the patches. In some cases, the masked distillation system 102 masks a random number or percentage of patches (e.g., within a percentage window) or masks a set number of patches with a random selection of which patches to mask.

In a similar fashion, the masked distillation system 102 generates training data for the text encoder 304, including a masked text phrase 330 from a sample text phrase 326 (as part of paired training data). Indeed, the masked distillation system 102 tokenizes the sample text phrase 326 and masks one or more tokens (e.g., words or characters) of the sample text phrase 326 to generate the masked text phrase 330.

As indicated, the masked distillation system 102 utilizes a contrastive learning process to align vision embeddings and language embeddings. To elaborate, the masked distillation system 102 utilizes the vision encoder 302 to process the masked digital image 314 and generate an image embedding 318. In particular, the vision encoder 302 extracts or generates the image embedding 318 as a latent vector representation of the masked digital image 314. In addition, the masked distillation system 102 utilizes the text encoder 304 to extract a text embedding 336 from the masked text phrase 330. In some embodiments, the masked distillation system 102 generates the text embedding 336 and the image embedding 318 represented by:

v(xᵢ)∈

[symbol]

and

t(yᵢ)∈

[symbol]

where v(xᵢ) represents the image embedding 318 and t(yᵢ) represents the text embedding 336.

As part of the contrastive learning objective, the masked distillation system 102 combines (e.g., averages) one or more of the vectors within the image embedding 318 into an averaged image embedding. Likewise, the masked distillation system 102 combines (e.g., averages) one or more of the vectors within the text embedding 336 into an averaged text embedding. For instance, the masked distillation system 102 generates an averaged image embedding represented by v(xᵢ) and an averaged text embedding represented by t(yᵢ) as the averages of all final layer token/patch embeddings after a learned linear projection (e.g., projecting dᵥ to d for the vision encoder 302) into the unified embedding space.

As further illustrated in FIG. 3, the masked distillation system 102 utilizes a contrastive loss 320 to learn parameters for the vision encoder 302 and the text encoder 304 for aligning vision embeddings and text embeddings in the unified embedding space. For example, the masked distillation system 102 utilizes a symmetric noise contrastive estimation loss, such as InfoNCE, as described by Aäron van den Oord et al. in REPRESENTATION LEARNING WITH CONTRASTIVE PREDICTIVE CODING, arXiv, abs/1807.03748 (2018). Specifically, the masked distillation system 102 formulates the contrastive loss 320 as the following:

$${ℒ}_{CLIP} = {ℒ}_{I \to T} + {ℒ}_{T \to I}$$

where [symbol] _{CLIP} represents the overall contrastive loss 320, with

$${ℒ}_{I \to T} = - \frac{1}{B} {\sum }_{i}^{B} log \frac{exp ( v ( {x}_{i} ) \cdot t ( {y}_{i} ) / τ )}{{\sum }_{j = 1}^{B} exp ( v ( {x}_{i} ) \cdot t ( {y}_{j} ) / τ )}$$

$${ℒ}_{T \to I} = - \frac{1}{B} {\sum }_{i}^{B} log \frac{exp ( v ( {x}_{i} ) \cdot t ( {y}_{i} ) / τ )}{{\sum }_{j = 1}^{B} exp ( v ( {x}_{j} ) \cdot t ( {y}_{i} ) / τ )}$$

where τ is a learned temperature parameter, and B is the size of a training mini-batch.

In addition to using the contrastive loss 320, the masked distillation system 102 also utilizes one or more masked distillation losses to train the vision encoder 302 and the text encoder 304. The distillation objectives anchor learned student representations (of the vision encoder 302 and the text encoder 304) with strong pretrained visual and textual representations that capture the structure of visual and textual data. In some embodiments, the text encoder 304 inherits teacher language tokenizers. In addition, the masked distillation system 102 utilizes a masked setting (e.g., by masking input data, as described) where student networks (e.g., the vision encoder 302 and the text encoder 304) only partially observe the input and must recover latent teacher representations of masked and unmasked input tokens. This masked reconstruction task additionally steers the vision encoder 302 and the text encoder 304 to learn structural patterns in the inputs.

To facilitate modifying encoder parameters through masked distillation, the masked distillation system 102 generates training data for inputting into foundational teacher models. For example, the masked distillation system 102 subsamples training data to provide to foundational models. Specifically, when performing masked distillation between foundation models and encoders of the vision-language model, the masked distillation system 102 utilizes only a subset of the overall number of training pairs used for contrastive learning. Thus, beyond patchifying and masking the digital image 310 for providing to the vision encoder 302, the masked distillation system 102 also subsamples images for providing to the vision foundation model 306. The masked distillation system 102 also divides the subsampled images into patches to generate the subsampled patches 312 for providing to the vision foundation model 306. Likewise, for the large language model 308, the masked distillation system 102 subsamples and tokenizes the sample text phrase 326 to generate a subsampled text phrase 328 for inputting into the large language model 308.

As further illustrated in FIG. 3, the masked distillation system 102 utilizes the vision foundation model 306 to process the subsampled patches 312 to generate a vision foundation embedding 316. Indeed, the vision foundation model 306 generates or extract the vision foundation embedding 316 in an embedding space having a dimensionality of the vision foundation model 306, where the vision foundation embedding 316 represents or defines the subsampled patches in latent vector form. Thus, as part of the masked distillation process, the masked distillation system 102 uses the vision foundation model 306 to generate an embedding for comparing with an embedding generated by the vision encoder 302 (e.g., the image embedding 318).

Similarly, the masked distillation system 102 utilizes the large language model 308 to process the subsampled text phrase 328 to generate a large language model embedding 338. Indeed, the large language model 308 extracts or encodes the large language model embedding 338 as a vector representation of the subsampled text phrase 328 using its large numbers of learned parameters trained over large amounts of data. Thus, as part of the masked distillation process, the masked distillation system 102 uses the large language model 308 to generate an embedding for comparing with an embedding generated by the text encoder 304 (e.g., the text embedding 336).

The masked distillation system 102 further projects embeddings of the vision encoder 302 and the text encoder 304 into embedding spaces of the respective foundational models. For example, the masked distillation system 102 learns a linear projection to map features of the unified embedding space (from the vision encoder 302 and the text encoder 304) to features of the vision foundation model 306 (or vice-versa). In addition, the masked distillation system 102 learns a linear projection to map features of the unified embedding space to features of the large language model 308 (or vice-versa).

In certain embodiments, the masked distillation system 102 projects features on a per-patch level and/or a per-token level. Specifically, the masked distillation system 102 performs a projection 322 to project vision encoder features to compare patch-level embeddings generated by the vision encoder 302 with corresponding patch-level embeddings generated by the vision foundation model 306. Similarly, the masked distillation system 102 performs a projection 340 to project text encoder embeddings to compare token-level embeddings generated by the text encoder 304 with corresponding token-level embeddings generated by the large language model 308. Indeed, as shown, the masked distillation system 102 normalizes the vision foundation embedding 316 and the large language model embedding 338 to compare individual patch embeddings using a per patch loss 324 and a per token loss 342, respectively.

In some embodiments, the per patch loss 324 and the per token loss 342 are masked distillation loss functions. For instance, the per patch loss 324 determines a measure of loss between patch-level embeddings generated from the masked digital image 314 with patch-level embeddings generated from the subsampled patches 312. Likewise, the per token loss 342 determines a measure of loss between token-level embeddings generated from the masked text phrase 330 with token-level embeddings generated from the subsampled text phrase 328.

In one or more embodiments, the masked distillation system 102 utilizes a masked distillation loss for the vision encoder 302 (e.g., the per patch loss 324) given by:

$${ℒ}_{V D} = {‖ V ( {M}_{v} ⊙ x ) - {V}_{teacher} ( x ) ‖}_{2}^{2}$$

and utilizes a masked distillation loss for the text encoder 304 (e.g., the per token loss 342) given by:

$${ℒ}_{T D} = {‖ T ( {M}_{t} ⊙ y ) - {T}_{teacher} ( y ) ‖}_{2}^{2}$$

where My and Mt are masks that randomly zero out a set of student input patches/tokens. In some cases, the masked distillation system 102 normalizes the outputs of both teacher models (e.g., the vision foundation model 306 and the large language model 308) in the loss calculation and learns linear projections (e.g., projection 322 and projection 340) from the outputs of V (the vision encoder 302) and T (the text encoder 304) to teacher output features (where the teacher and student feature dimensions can be different). Thus, using the per patch loss 324 and the per token loss 342 over multiple training iterations, the masked distillation system 102 modifies parameters of the vision encoder 302 and the text encoder 304 to generate embeddings that more closely resemble foundation embeddings generated by the respective foundation models (e.g., over a set number of iterations/epochs or until satisfying a threshold measure of per patch loss).

In some embodiments, the masked distillation system 102 uses the masked distillation losses on only a random subset (below a threshold size) of each training mini-batch. By training over mini-batches as opposed to distilling over every training pair, the masked distillation system 102 exhibits a positive influence of masked distillation while preserving high training throughput. Additionally, the masked distillation system 102 is able to precompute teacher representations (e.g., using the lookup table of the embedding projection 334) to avoid online computation of targets during training, trading off additional storage requirements for a negligible amount of training overhead when compared to conventional contrastive vision-language training.

In one or more embodiments, the masked distillation system 102 employs an overall training objective for the vision-language model, incorporating masked distillation losses and contrastive losses together. Indeed, the masked distillation system 102 learns parameters for the vision encoder 302 and the text encoder 304 using an overall training objective given by:

$${ℒ}_{t otal} = {ℒ}_{CLIP} + {λ}_{1} {ℒ}_{V D} + {λ}_{2} {ℒ}_{T D}$$

where λ₁ and λ₂ weigh the contribution of the distillation terms. In this multitask objective, the masked distillation system 102 interprets [symbol] _{CLIP} as aligning the two modalities while [symbol] _{VD} and [symbol] _{TD} anchor the visual and textual encoders with strong pre-existing representations of visual and textual data.

As further illustrated in FIG. 3, the masked distillation system 102 further learns an embedding projection 334 for the text encoder 304 from text embeddings 332 of the large language model 308. To elaborate, the masked distillation system 102 learns to project text embeddings 332 extracted by the large language model 308 as a lookup table that maps or projects the text embeddings 332 for each word or token in a vocabulary. The text encoder 304 thus learns the embedding projection 334 (e.g., the lookup table) from the frozen features of the large language model 308 by projecting from the dimensionality of the large language model 308 to the dimensionality of the text encoder 304. Not only does learning the embedding projection 334 speed up training and improve downstream performance, but experimenters have observed that the text encoder 304 also inherits multilingual capabilities of the large language model 308 as well (without training on multilingual paired data).

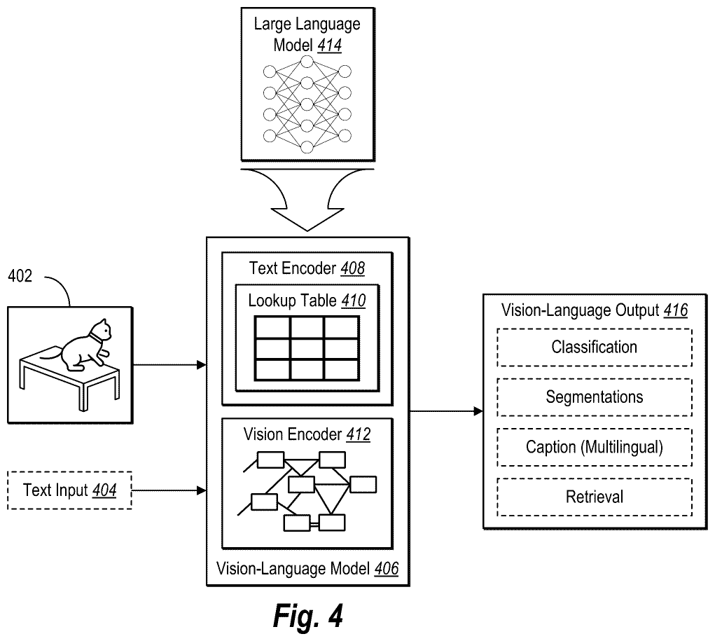

As mentioned, in certain embodiments, the masked distillation system 102 implements or utilizes a vision-language model to generate a vision-language output. In particular, the masked distillation system 102 implements a vision-language model trained using masked distillation, projections, and/or contrastive learning as described herein. FIG. 4 illustrates an example diagram for implementing a trained vision-language model to generate a vision-language output in accordance with one or more embodiments.

As illustrated in FIG. 4, the masked distillation systems 102 inputs a digital image 402 into a vision-language model 406. In response, the vision-language model 406 processes the digital image 402 to generate a vision-language output 416. To elaborate, the vision-language model 406 utilizes a vision encoder 412 to extract or encode an image embedding from the digital image 402. In addition, the vision-language model 406 utilizes a vision decoder to decode the extracted image embedding into a vision-language output 416. In one or more embodiments, the vision encoder 412 learns a projection of vision foundation model features and, upon implementation, utilize the projection to generate an image embedding (and to ultimately generate the vision-language output 416). Thus, rather than utilizing a vision foundation model to process input data on implementation, the vision-language model 406 utilizes projected features of the vision encoder 412, achieving the accuracy of the vision foundation model without the computational expense of implementing the vision foundation model.

In some cases, the vision-language model 406 generates the vision-language output 416 from a combination of image features and text features embedded in a unified embedding space. Indeed, the vision-language model 406 includes a text encoder 408 that learns or projects a lookup table 410 to use in generating or extracting text embeddings. For example, the text encoder 408 projects the lookup table 410 from a large language model 414. In some cases, the lookup table 410 includes a mapping of words (or tokens) to their corresponding latent vector representations as learned by the large language model 414 during its training over vast amounts of training data. During training of the vision-language model 406, the text encoder 408 learns to project the lookup table 410 based on learned features of the large language model 414 and projects the lookup table 410 into its own dimensionality of the unified embedding space. Thus, the vision-language model 406 utilizes the lookup table 410 to generate text embeddings (e.g., vectors representing words or tokens) in the unified embedding space (and to ultimately generate the vision-language output 416) rather than utilizing the large language model 414 to process input data on implementation. The vision-language model 406 thus achieves the accuracy and function (including multilingual function) of the large language model 414 while preserving the computational expense of implementing the large language model 414.

As shown in FIG. 4, the vision-language model 406 generates the vision-language output 416 as one or more of a classification, a segmentation, a caption, or a retrieval. Indeed, the vision-language model 406 generates the vision-language output 416 by processing features extracted from the digital image 402 (or input text data) within the unified embedding space of the text encoder 408 and the vision encoder 412. Indeed, the vision-language model 406 processes vision-language features utilizing the lookup table 410 and/or projected vision-based features. The vision-language model 406 thus generates the vision-language output 416 in a variety of forms based on the relationships between text and image data indicated by extracted features in the unified embedding space.

As an example of classification, the vision-language model 406 generates an image classification for the digital image 402. For instance, the masked distillation system 102 generates a text phrase of one or more words that define a classification or a label of one or more objects depicted within the digital image 402 and/or for the digital image 402 as a whole. In some cases, the vision-language model 406 generates a multilingual caption by generating a label defining (one or more objects depicted in) the digital image 402 in a language other than English. Indeed, despite training only on monolingual data, the vision-language model 406 exhibits multilingual capabilities via the lookup table 410 projected from the large language model 414.

As an example of segmentation, the vision-language model 406 generates segmentations for the digital image 402 by dividing, segmenting, or partitioning the digital image 402 to delineate or demarcate between pixels depicting different objects or image portions. For instance, the vision-language model 406 generates segmentations indicating boundaries between objects of different labels, such as sky and ground pixels, car and tree pixels, and/or background and foreground pixels. Indeed, by projecting features from a vision foundation model into the vision encoder 412, the vision-language model 406 learns to perform segmentations without expressly training on segmentation data.

As an example of captioning, the vision-language model 406 generates an output text phrase to caption the digital image 402. For instance, the vision-language model 406 generates a caption that describes what is shown in the digital image 402 in sentence form. In certain cases, the vision-language model 406 generates the caption as dialogue to explain what is shown in the digital image 402 and/or what a person or entity depicted in the digital image 402 is saying (e.g., based on image context). In some embodiments, the vision-language model 406 generates a multilingual caption in a non-English language. Indeed, by projecting and utilizing the lookup table 410, the vision-language model 406 is able to generate captions using multilingual capabilities inherited from the large language model 414.

As an example of retrieval, the vision-language model 406 processes the digital image 402 to search a database or repository to identify digital images or other stored content items corresponding to the digital image 402. For instance, the vision-language model 406 identifies digital images depicting content similar to that of the digital image 402 (e.g., with one or more commonly shared objects. As another example, the vision-language model 406 identifies digital documents, emails, or other content items that mention content depicted by the digital image 402 (e.g., that mention depicted objects or scenes). In generating or retrieving digital images, the vision-language model 406 exhibits a strong understanding of compositional context. Specifically, the vision-language model 406 generates or retrieves digital images that match or align with compositional cues on the text input 404, where the words define relationships between objects in the image (e.g., “cat on desk,” or “person next to car in front of a building”).

In generating the vision-language output 416 in its various forms, the vision-language model 406 exhibits strong compositional understanding. Specifically, the vision-language model 406 generates captions, segmentations, retrievals, and/or other outputs with correct relational context among depicted objects. In addition, the vision-language model 406 generates accurate outputs that reflect nuances and details often missed by other systems, such as adjectives indicating color, size, placement, or other visual attributes.

As further illustrated in FIG. 4, in some embodiments, the masked distillation system 102 inputs a text input 404 into the vision-language model 406. The vision-language model 406, in turn, processes the text input 404 to generate a vision-language output 416. For instance, the vision-language model 406 generates a digital image from the text input 404 by generating pixels representing or reflecting subject matter described by the text input 404. As another example, the vision-language model 406 retrieves one or more stored digital images that reflect or depict digital content corresponding to (e.g., mentioned or described by) the text input 404.

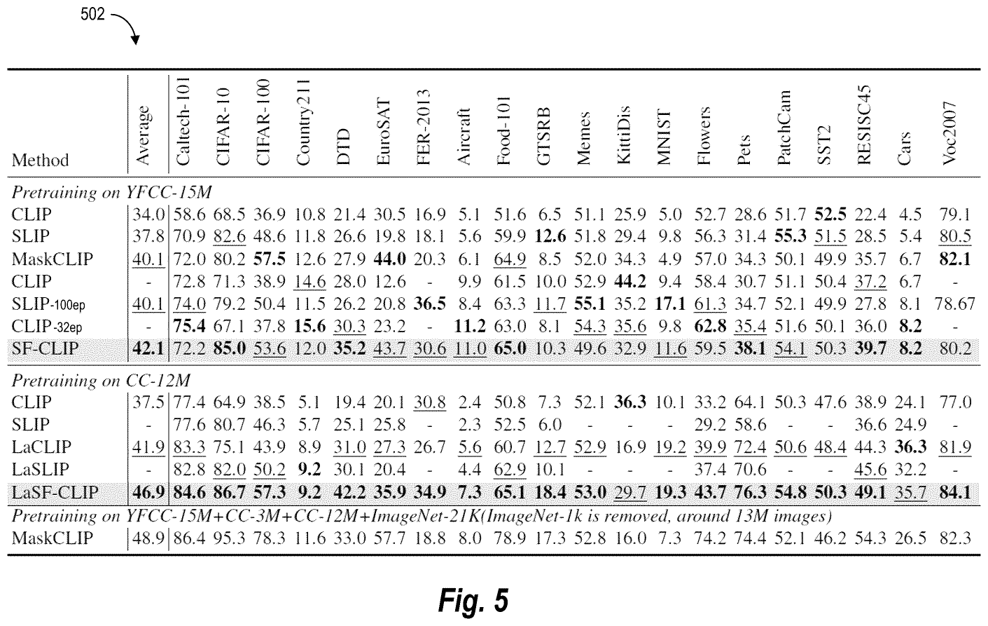

As mentioned, in certain described embodiments, the masked distillation system 102 shows improved performance over prior vision-language systems. In particular, the masked distillation system 102 trains a vision-language model for more accurate vision-language output generation. FIG. 5 illustrates a table of experimental results demonstrating improvements of the masked distillation system 102 in accordance with one or more embodiments.

As illustrated in FIG. 5, the table 502 includes experimental results for a number of vision-language models across a variety of datasets. For the experiments, the masked distillation system 102 utilizes a vision-language model that includes a vision encoder based on the VIT-B/16 architecture described by Alexey Dosovitskiy et al. in AN IMAGE IS WORTH 16×16 WORDS: TRANFORMERS FOR IMAGE RECOGNITION AT SCALE, arXiv, abs/2010.11929 (2020). In addition, the masked distillation system 102 utilizes a text encoder based on CLIP described by Alec Radford et al. in LEARNING TRANSFERABLE VISUAL MODELS FROM NATURAL LANGUAGE SUPER VISION, Int'l Conf. on Machine Learning (2021). Experimenters masked up to 25% of text tokens and none of the vision tokens with a subset of 1024 images for vision teachers and 512 text phrases for text teachers. Values of 11 and 12 were set to 1.

The table 502 shows classification benchmarks with the best result in bold and the second best results underlined. To generate the results of the table 502, experimenters used the twenty datasets of the Image Classification in the Wild challenge proposed by Chunyuan Li et al. in A BENCHMARK AND TOOLKIT FOR EVALUATING LANGUAGE-AUGMENTED VISUAL MODELS, Neural Information Processing Systems (2022). Each of the twenty datasets are shown across the top of the table 502, while each tested model is shown down the left side. The model “SF-CLIP” represents one embodiment the masked distillation system 102 described herein. Likewise, the model “LaSF-CLIP” represents an embodiment of the masked distillation system 102 described herein as well.

As shown in the table 502, when training over the YFCC-15M dataset, the masked distillation system 102 exhibits the best average performance for zero shot classification across the twenty classification datasets, even compared to previous state of the art models, such as CLIP. Similarly, when training over the CC-12M dataset, the masked distillation system 102 exhibits the best average performance and many best performances in each of the twenty classification datasets.

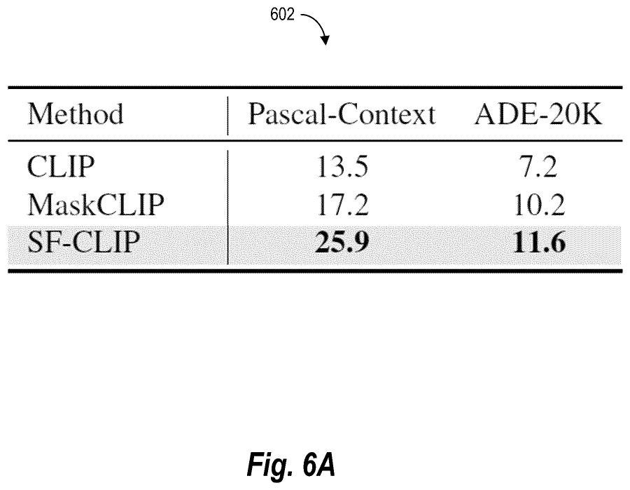

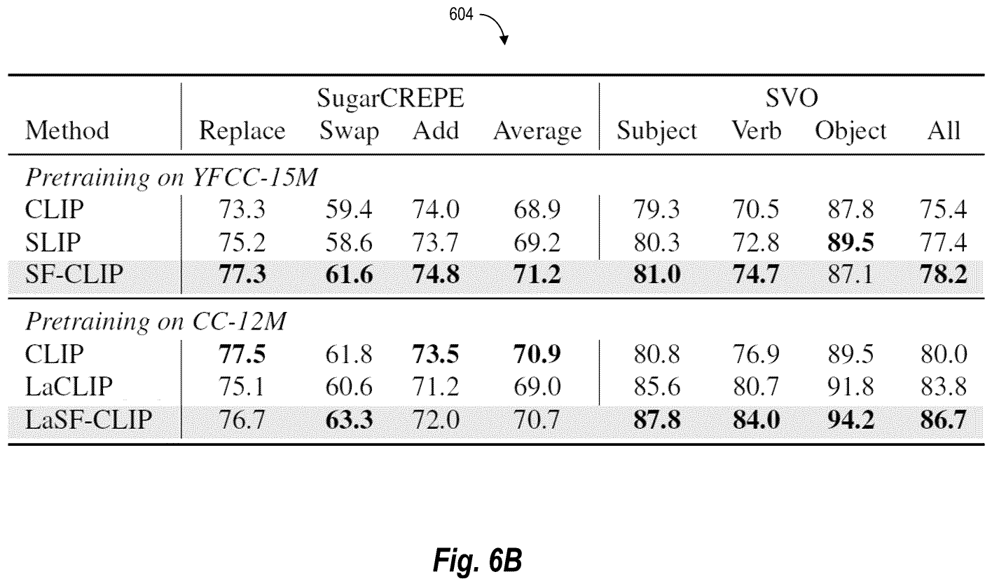

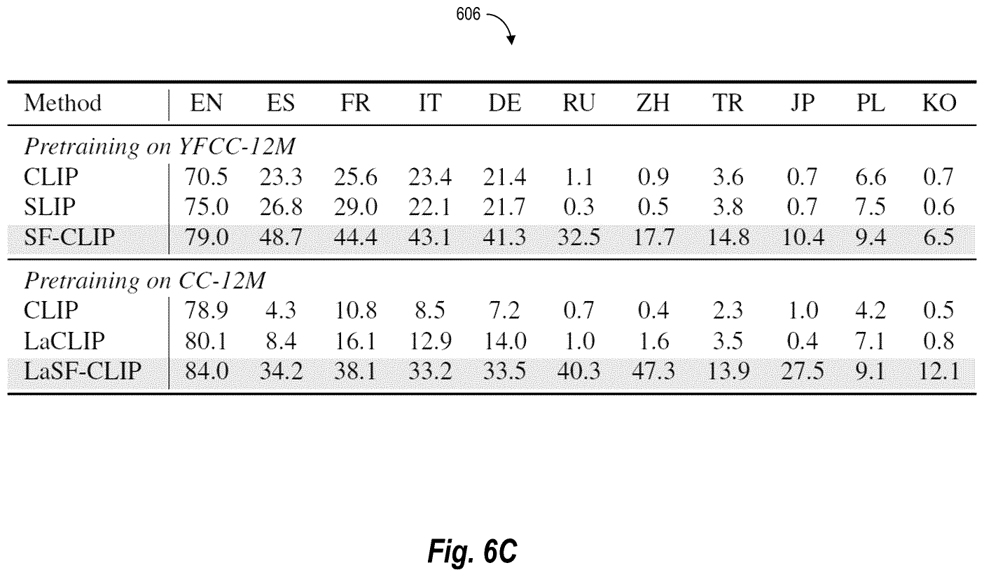

As mentioned above, the masked distillation system 102 generates other types of vision-language outputs as well. Indeed, beyond classification, the masked distillation system 102 generates segmentations, captions, and/or retrievals. FIGS. 6A-6C illustrate experimental results for performance of the masked distillation system 102 against other vision-language systems across different types of vision-language output. Specifically, FIG. 6A illustrates results for zero shot segmentation. FIG. 6B illustrates results for compositional and verbal understanding for generating vision-language outputs (e.g., captions). FIG. 6C illustrates results for multilingual capabilities. The experiments of FIGS. 6A-6C use the same parameters as those for FIG. 5.

As illustrated in FIG. 6A, the table 602 depicts mean intersection over union (mIoU) percentages for three different models. As demonstrated, the masked distillation system 102 (SF-CLIP) performs better zero shot segmentation than CLIP and MaskCLIP over the Pascal-Context dataset and the ADE-20K dataset, exhibiting more accurate image segmentation. Indeed, the masked distillation system 102 learns to segment digital images without ever expressly training on segmentation data. This is because the vision-language model trained by the masked distillation system 102 inherits additional spatial understanding through vision-based masked distillation.

As illustrated in FIG. 6B, the table 604 depicts experimental results testing compositional understanding and verbal understanding of different vision-language models. For example, experimenters tested models using the SugarCREPE dataset to determine compositional image understanding for relationships between objects in an image. Experimenters tested models using the SVO dataset to determine linguistic understanding. As shown, table 604 includes results for different types of compositional understanding (e.g., replace, swap, and add functions) and verbal understanding (e.g., subject, verb, and object). Higher numbers indicate better performance. The masked distillation system 102 (SF-CLIP and LaSF-CLIP) performs better than prior models in all categories except object understanding when trained on the YFCC-15M dataset. The masked distillation system 102 performs better on all linguistic understanding tests when trained on the CC-12M dataset.

As illustrated in FIG. 6C, the table 606 performance results across various languages, such as English, Spanish, French, Italian, German, Russian, and others (as indicated by the abbreviations across the columns in the “Method” row. As shown, the masked distillation system 102 (SF-CLIP and LaSF-CLIP) outperforms other vision-language models across all languages, whether training on YFCC-12M data or CC-12M data. Indeed, the masked distillation system 102 exhibits substantial improvement in multilingual capabilities for generating non-English captions and other vision-language output compared to prior systems. Thus, even though the masked distillation system 102 trains only on monolingual data, the masked distillation system 102 nevertheless inherits multilingual capabilities of a pretrained large language model, such as the XGLM-1.7B model described by Xi Victoria Lin et al. in FEW-SHOT LEARNING WITH MULTI-LINGUAL LANGUAGE MODELS, arXiv, account backup system/2112.10668 (2021).

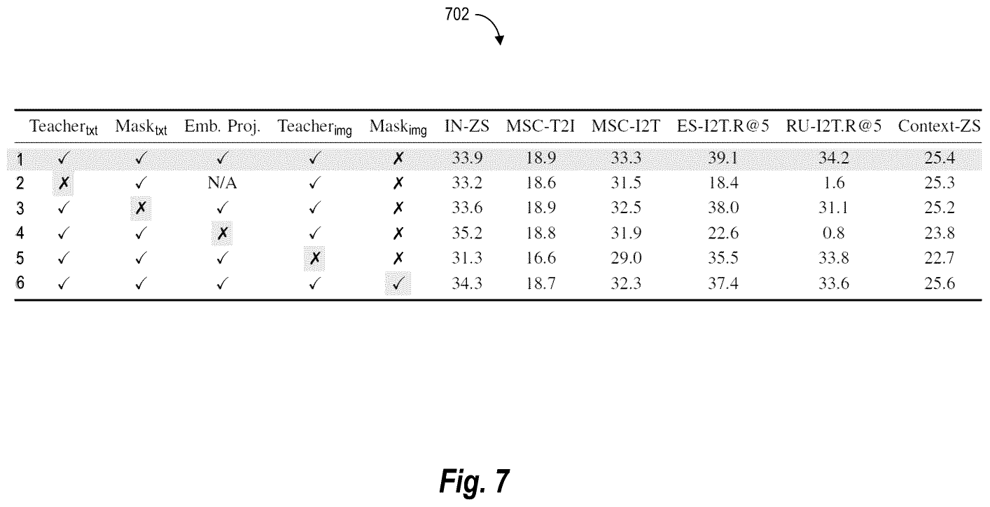

In one or more embodiments, the experimenters further performed ablation studies to demonstrate the contributions of different architectural components of the masked distillation system 102. In particular, experimenters tested the impact of removing certain aspects of the vision-language model trained by masked distillation system 102. FIG. 7 illustrates ablation study results in accordance with one or more embodiments.

As illustrated in FIG. 7, the table 702 depicts a series of six experiments, where an “x” indicates that the corresponding component has been removed for the test. As demonstrated in experiment 2, removing the text teacher (or not inheriting word embeddings) removes multilingual capabilities (e.g., the 1.6 for Russian output). In addition, as shown by experiment 5, removing the vision teacher results in decreased performance in all tested metrics. Further, comparing experiment 6 with the other five, table 702 shows improved performance from masking digital images for input.

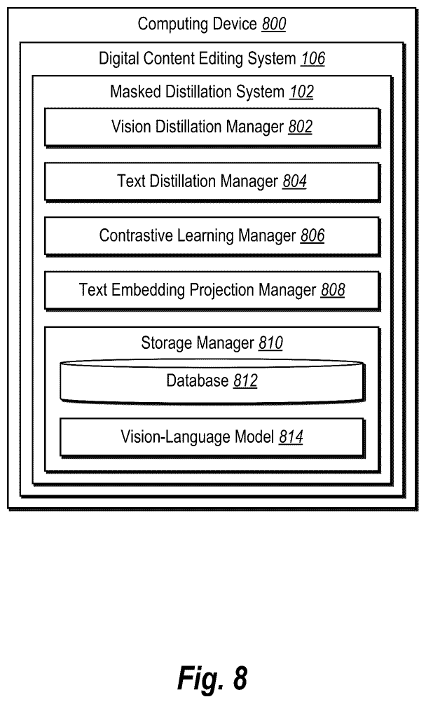

Looking now to FIG. 8, additional detail will be provided regarding components and capabilities of the masked distillation system 102. Specifically, FIG. 8 illustrates an example schematic diagram of the masked distillation system 102 on an example computing device 800 (e.g., one or more of the client device 108 and/or the server(s) 104). In some embodiments, the computing device 800 refers to a distributed computing system where different managers are located on different devices, as described above. As shown in FIG. 8, the masked distillation system 102 includes a vision distillation manager 802, a text distillation manager 804, a contrastive learning manager 806, an embedding projection manager 808, and a storage manager 810.

As just mentioned, the masked distillation system 102 includes a vision distillation manager 802. In particular, the vision distillation manager 802 manages, determines, trains, distills, learns, generates, modifies, adjusts, teaches, or transfers parameters of a vision encoder. For instance, the vision distillation manager 802 distills vision-based parameters from a vision foundation model to a vision encoder (and/or a vision decoder) of a vision-language model. In some embodiments, the vision distillation manager 802 uses masked distillation to distill parameters as described herein.

As illustrated in FIG. 8, the masked distillation system 102 also includes a text distillation manager 804. In particular, the text distillation manager 804 manages, determines, trains, distills, learns, generates, modifies, adjusts, teaches, or transfers parameters of a text encoder. For instance, the text distillation manager 804 distills text-based parameters from a large language model to a text encoder (and/or a text decoder) of a vision-language model. In some embodiments, the text distillation manager 804 uses masked distillation to distill parameters as described herein.

As further illustrated in FIG. 8, the masked distillation system 102 includes a contrastive learning manager 806. In particular, the contrastive learning manager 806 utilizes a contrastive image-text training approach to manage, maintain, determine, learn, adjust, modify, or train parameters of a vision-language model. For instance, the contrastive learning manager 806 utilizes one or more contrastive loss functions to guide parameters of a vision encoder and/or a text encoder of a vision-language model to extract respective embeddings within a unified embedding space as described herein.

Additionally, the masked distillation system 102 includes an embedding projection manager 808. In particular, the embedding projection manager 808 manages, determines, generates, learns, projects, or identifies one or more projections for projecting or translating features from one dimensionality to another. For instance, the embedding projection manager 808 learns a linear projection for projecting features of a unified embedding space of a vision-language model to an embedding space in a dimensionality of a large language model (or vice-versa). As another example, the embedding projection manager 808 learns a linear projection for projecting features of the unified embedding space to an embedding space in a dimensionality of a vision foundation model (or vice-versa). In some embodiments, the embedding projection manager 808 learns to project a lookup table from a large language model so that, upon implementation, the vision-language model need only utilize the data in the lookup table to generate a vision-language output rather than process data through the large language model.

The masked distillation system 102 further includes a storage manager 810. The storage manager 810 operates in conjunction with, or includes, one or more memory devices such as the database 812 (e.g., the database 114) that store various data such as training pairs (e.g., masked digital images and masked text phrases), projected lookup tables (e.g., from large language models), and/or vision-language outputs. As shown, the storage manager 810 also stores and maintains a vision-language model 814 accessible for training and implementing by one or more other components of the masked distillation system 102. The storage manager 810 communicates with the other components of the masked distillation system 102 to facilitate the operations and functions described herein.

In one or more embodiments, each of the components of the masked distillation system 102 are in communication with one another using any suitable communication technologies. Additionally, the components of the masked distillation system 102 is in communication with one or more other devices including one or more client devices described above. It will be recognized that although the components of the masked distillation system 102 are shown to be separate in FIG. 8, any of the subcomponents may be combined into fewer components, such as into a single component, or divided into more components as may serve a particular implementation. Furthermore, although the components of FIG. 8 are described in connection with the masked distillation system 102, at least some of the components for performing operations in conjunction with the masked distillation system 102 described herein may be implemented on other devices within the environment.

The components of the masked distillation system 102, in one or more implementations, includes software, hardware, or both. For example, the components of the masked distillation system 102 include one or more instructions stored on a computer-readable storage medium and executable by processors of one or more computing devices (e.g., the computing device 800). When executed by the one or more processors, the computer-executable instructions of the masked distillation system 102 cause the computing device 800 to perform the methods described herein. Alternatively, the components of the masked distillation system 102 comprises hardware, such as a special purpose processing device to perform a certain function or group of functions. Additionally, or alternatively, the components of the masked distillation system 102 includes a combination of computer-executable instructions and hardware.

Furthermore, the components of the masked distillation system 102 performing the functions described herein may, for example, be implemented as part of a stand-alone application, as a module of an application, as a plug-in for applications including content management applications, as a library function or functions that may be called by other applications, and/or as a cloud-computing model. Thus, the components of the masked distillation system 102 may be implemented as part of a stand-alone application on a personal computing device or a mobile device. Alternatively, or additionally, the components of the masked distillation system 102 may be implemented in any application that allows creation and delivery of marketing content to users, including, but not limited to, applications in ADOBE® EXPERIENCE MANAGER and CREATIVE CLOUD®, such as ADOBE® FIREFLY, ADOBE® EXPRESS, PHOTOSHOP®, ILLUSTRATOR®, and INDESIGN®. “ADOBE,” “ADOBE EXPERIENCE MANAGER,” “CREATIVE CLOUD,” “ADOBE FIREFLY,” “ADOBE EXPRESS,” “PHOTOSHOP,” “ILLUSTRATOR,” and “INDESIGN” are either registered trademarks or trademarks of Adobe Inc. in the United States and/or other countries.

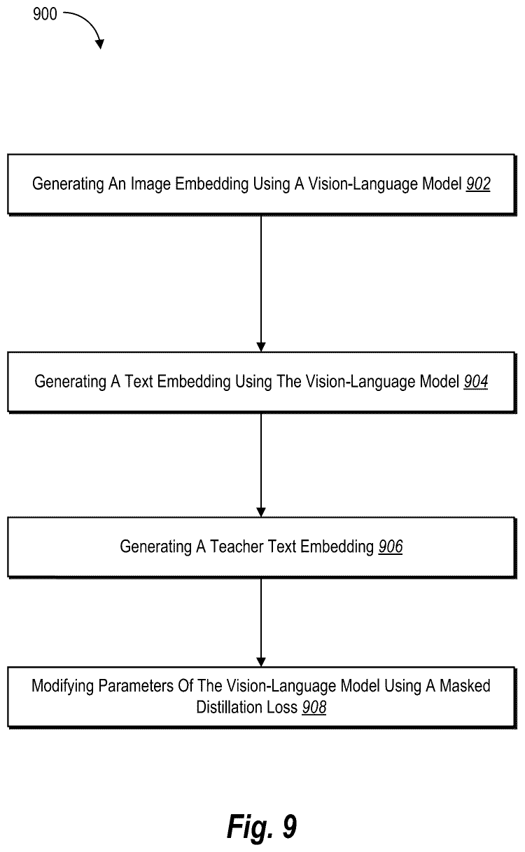

FIGS. 1-8 the corresponding text, and the examples provide a number of different systems, methods, and non-transitory computer readable media for training and implementing a vision-language model using masked distillation and contrastive image-text training. In addition to the foregoing, embodiments are describable in terms of flowcharts comprising acts for accomplishing a particular result. For example, FIGS. 9-11 illustrate flowcharts of example sequences or series of acts in accordance with one or more embodiments.

While FIGS. 9-11 illustrate acts according to particular embodiments, alternative embodiments may omit, add to, reorder, and/or modify any of the acts shown in FIGS. 9-11. The acts of FIGS. 9-11 are be performed as part of a method. Alternatively, a non-transitory computer readable medium comprises instructions, that when executed by one or more processors, cause a computing device to perform the acts of FIGS. 9-11. In still further embodiments, a system performs the acts of FIGS. 9-11. Additionally, the acts described herein may be repeated or performed in parallel with one another or in parallel with different instances of the same or other similar acts.

FIG. 9 illustrates an example series of acts 900 for training a vision-language model using masked distillation and contrastive image-text training. As illustrated in FIG. 9, the series of acts 900 includes an act 902 of generating an image embedding using a vision-language model. In particular, the act 902 involves generating, utilizing a vision encoder of a vision-language model, an image embedding in a unified embedding space of the vision-language model from a masked digital image comprising a digital image with one or more masked patches. In addition, the series of acts 900 includes an act 904 of generating a text embedding using the vision-language model. In particular, the act 904 involves generating, utilizing a text encoder of the vision-language model, a text embedding in the unified embedding space from a masked text phrase comprising a text description of the digital image with one or more masked tokens. Further, the series of acts 900 includes an act 906 of a teacher text embedding. In particular, the act 906 involves generating, utilizing a pretrained large language model, a teacher text embedding of the text description. Further, the series of acts 900 includes an act 908 of modifying parameters of the vision-language model using a masked distillation loss. In particular, the act 908 involves modifying parameters of the vision-language model according to a masked distillation loss between the teacher text embedding and the text embedding generated by the text encoder.

In one or more embodiments, the series of acts 900 includes an act of modifying the parameters of the vision-language model according to an additional masked distillation loss between the image embedding generated by the vision encoder and a teacher image embedding generated by a pretrained vision foundation model. In these or other embodiments, series of acts 900 includes an act of modifying the parameters of the vision-language model according to the additional masked distillation loss comprises distilling features learned by the pretrained vision foundation model into the vision encoder of the vision-language model to encourage the vision encoder to learn to replicate the teacher image embedding of the pretrained vision foundation model from the masked digital image.

In some embodiments, the series of acts 900 includes an act of modifying the parameters of the vision-language model according to the masked distillation loss by distilling features learned by the pretrained large language model into the text encoder of the vision-language model to encourage the text encoder to learn to replicate the teacher text embedding of the pretrained large language model from the masked text phrase. In certain cases, the series of acts 900 includes acts of extracting the text embedding by utilizing the text encoder of the vision-language model to project features from the unified embedding space of the vision encoder and the text encoder to a dimensionality of the pretrained large language model into and modifying the parameters of the vision-language model based on projecting the features.

In one or more embodiments, the series of acts 900 includes an act of extracting the image embedding by utilizing the vision encoder of the vision-language model to project features from the unified embedding space of the vision encoder and the text encoder to a dimensionality of a pretrained vision foundation model and an act of modifying the parameters of the vision-language model based on projecting the features. Further, in certain cases, the series of acts 900 includes an act of modifying the parameters of the vision-language model to learn a projection from multilingual text embeddings of the pretrained large language model to text input embeddings of the text encoder.

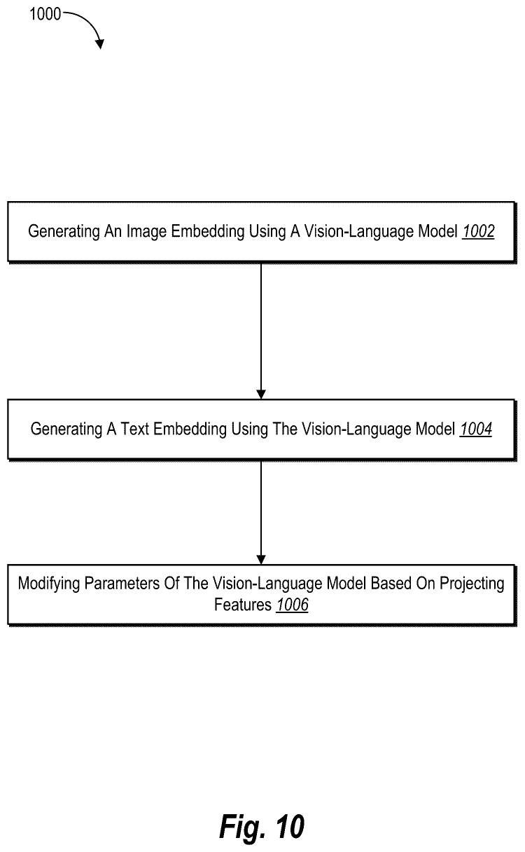

FIG. 10 illustrates an example series of acts 1000 for training a vision-language model using feature projections from (or to) dimensionalities of foundational models. As shown, the series of acts 1000 includes an act 1002 of generating an image embedding using a vision-language model. In particular, the act 1002 involves generating, utilizing a vision encoder of a vision-language model, an image embedding in a unified embedding space of the vision-language model from a masked digital image comprising a digital image with one or more masked patches. In addition, the series of acts 1000 includes an act 1004 of generating a text embedding using the vision-language model. In particular, the act 1004 involves generating, utilizing a text encoder of the vision-language model and from a masked text phrase comprising a text description of the digital image with one or more masked tokens, a text embedding in the unified embedding space by projecting features from the unified embedding space to a dimensionality of a pretrained large language model. Further, the series of acts 1000 includes an act 1006 of modifying parameters of the vision-language model based on projecting features. In particular, the act 1006 involves modifying parameters of the vision-language model based on projecting the features.

In some embodiments, the series of acts 1000 includes an act of extracting the image embedding by utilizing the vision encoder of the vision-language model to project features from the unified embedding space to a dimensionality of a pretrained vision foundation model and an act of modifying the parameters of the vision-language model based on projecting the features to the pretrained vision foundation model. In certain cases, the series of acts 1000 includes acts of generating, utilizing the vision-language model to process the masked digital image and the masked text phrase, a predicted text embedding of the text description in a unified embedding space of the vision encoder and the text encoder and modifying the parameters of the vision-language model based on a masked distillation loss between the predicted text embedding and a teacher text embedding generated by the pretrained large language model.

In one or more embodiments, the series of acts 1000 includes an act of generating, utilizing the vision-language model to process the masked digital image and the masked text phrase, a predicted image reconstruction of the digital image in a unified embedding space of the vision encoder and the text encoder. In these or other embodiments, the series of acts 1000 includes an act of modifying the parameters of the vision-language model based on a masked distillation loss between the predicted image embedding and a teacher image embedding generated by a pretrained vision foundation model.

In some embodiments, the series of acts 1000 includes an act of modifying the parameters of the vision-language model to learn, without inputting multilingual training data into the vision-language model, a projection from multilingual text embeddings of the pretrained large language model to text input embeddings of the text encoder. In one or more embodiments, the series of acts 1000 includes acts of generating, utilizing the vision-language model to process the masked digital image and the masked text phrase, a predicted text embedding of the text description of the digital image and modifying the parameters of the vision-language model using a contrastive loss to predict correctness of the predicted text embedding. In some cases, the series of acts 1000 includes an act of generating, utilizing the vision-language model to process the masked digital image and the masked text phrase, a predicted image embedding of the digital image and an act of modifying the parameters of the vision-language model using a contrastive loss to predict correctness of the predicted image embedding.

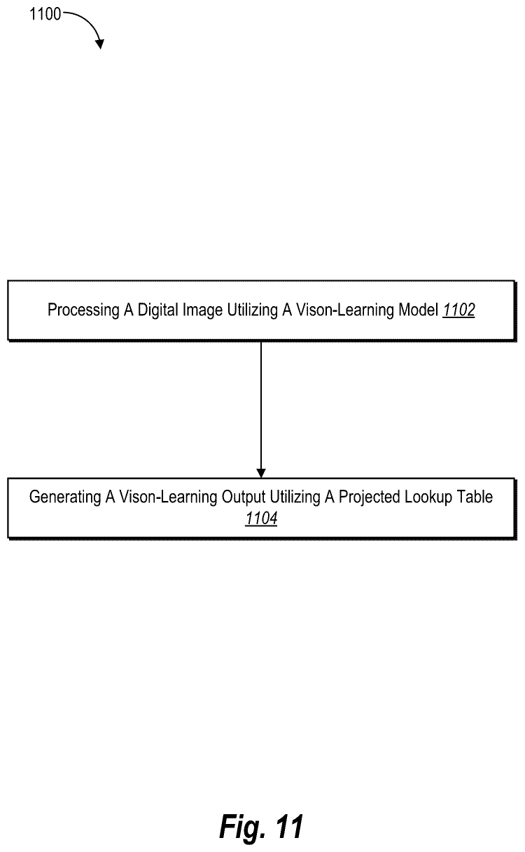

FIG. 11 illustrates an example series of acts 1100 for implementing a vision-language model to generate a vision-language output based on training from one or more foundational models. As shown, the series of acts 1100 includes an act 1102 of processing a digital image utilizing a vision-language model. In particular, the act 1102 involves processing a digital image utilizing a vision-language model comprising a vision encoder and a text encoder trained to project a lookup table of features from a dimensionality of a large language model trained on multilingual data into a unified embedding space of the vision encoder and the text encoder. In addition, the series of acts 1100 includes an act 1104 of generating a vision-language output utilizing a projected lookup table. In particular, the act 1104 involves generating, utilizing the vision-language model, a vision-language output by processing the digital image utilizing the lookup table projected by text encoder.

In some embodiments, the series of acts 1100 includes an act of generating the vision-language output by using the vision-language model to determine a classification of the digital image. In these or other embodiments, the series of acts 1100 includes an act of generating the vision-language output by using the vision-language model to determine segmentations of objects depicted within the digital image. In some cases, the series of acts 1100 includes an act of generating the vision-language output by using the vision-language model to generate a non-English caption for the digital image.

In some embodiments, the series of acts 1100 includes an act of generating the vision-language output by using the vision-language model to retrieve, from digital image database, one or more digital images corresponding to the digital image. In one or more embodiments, the series of acts 1100 includes an act of generating an additional vision-language output by using the vision-language model to generate a caption that describes relational composition of objects depicted in the digital image.

Embodiments of the present disclosure may comprise or use a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., memory), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) use transmission media.

Computer-executable instructions comprise, for example, instructions and data which, when executed by a processor, cause a general-purpose computer, special purpose computer, or special purpose processing device to perform a certain function or group of functions. In some embodiments, computer-executable instructions are executed by a general-purpose computer to turn the general-purpose computer into a special purpose computer implementing elements of the disclosure. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. As used herein, the term “cloud computing” refers to a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In addition, as used herein, the term “cloud-computing environment” refers to an environment in which cloud computing is employed.

FIG. 12 illustrates a block diagram of an example computing device 1200 that may be configured to perform one or more of the processes described above. One will appreciate that one or more computing devices, such as the computing device 1200 may represent the computing devices described above (e.g., computing device 800, server(s) 104, and/or client device 108). In one or more embodiments, the computing device 1200 may be a mobile device (e.g., a mobile telephone, a smartphone, a PDA, a tablet, a laptop, a camera, a tracker, a watch, a wearable device, etc.). In some embodiments, the computing device 1200 may be a non-mobile device (e.g., a desktop computer or another type of client device). Further, the computing device 1200 may be a server device that includes cloud-based processing and storage capabilities.

As shown in FIG. 12, the computing device 1200 can include one or more processor(s) 1202, memory 1204, a storage device 1206, input/output interfaces 1208 (or “I/O interfaces 1208”), and a communication interface 1210, which may be communicatively coupled by way of a communication infrastructure (e.g., bus 1212). While the computing device 1200 is shown in FIG. 12, the components illustrated in FIG. 12 are not intended to be limiting. Additional or alternative components may be used in other embodiments. Furthermore, in certain embodiments, the computing device 1200 includes fewer components than those shown in FIG. 12. Components of the computing device 1200 shown in FIG. 12 will now be described in additional detail.

In particular embodiments, the processor(s) 1202 includes hardware for executing instructions, such as those making up a computer program. As an example, and not by way of limitation, to execute instructions, the processor(s) 1202 may retrieve (or fetch) the instructions from an internal register, an internal cache, memory 1204, or a storage device 1206 and decode and execute them.

The computing device 1200 includes memory 1204, which is coupled to the processor(s) 1202. The memory 1204 may be used for storing data, metadata, and programs for execution by the processor(s). The memory 1204 may include one or more of volatile and non-volatile memories, such as Random-Access Memory (“RAM”), Read-Only Memory (“ROM”), a solid-state disk (“SSD”), Flash, Phase Change Memory (“PCM”), or other types of data storage. The memory 1204 may be internal or distributed memory.

The computing device 1200 includes a storage device 1206 includes storage for storing data or instructions. As an example, and not by way of limitation, the storage device 1206 can include a non-transitory storage medium described above. The storage device 1206 may include a hard disk drive (HDD), flash memory, a Universal Serial Bus (USB) drive or a combination these or other storage devices.

As shown, the computing device 1200 includes one or more I/O interfaces 1208, which are provided to allow a user to provide input to (such as user strokes), receive output from, and otherwise transfer data to and from the computing device 1200. These I/O interfaces 1208 may include a mouse, keypad or a keyboard, a touch screen, camera, optical scanner, network interface, modem, other known I/O devices or a combination of such I/O interfaces 1208. The touch screen may be activated with a stylus or a finger.

The I/O interfaces 1208 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O interfaces 1208 are configured to provide graphical data to a display for presentation to a user. The graphical data may be representative of one or more graphical user interfaces and/or any other graphical content as may serve a particular implementation.

The computing device 1200 can further include a communication interface 1210. The communication interface 1210 can include hardware, software, or both. The communication interface 1210 provides one or more interfaces for communication (such as, for example, packet-based communication) between the computing device and one or more other computing devices or one or more networks. As an example, and not by way of limitation, communication interface 1210 may include a network interface controller (NIC) or network adapter for communicating with an Ethernet or other wire-based network or a wireless NIC (WNIC) or wireless adapter for communicating with a wireless network, such as a WI-FI. The computing device 1200 can further include a bus 1212. The bus 1212 can include hardware, software, or both that connects components of computing device 1200 to each other.

In the foregoing specification, the invention has been described with reference to specific example embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel to one another or in parallel to different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A computer-implemented method comprising:
generating, utilizing a vision encoder of a vision-language model, an image embedding in a unified embedding space of the vision-language model from a masked digital image comprising a digital image with one or more masked patches;
generating, utilizing a text encoder of the vision-language model, a text embedding in the unified embedding space from a masked text phrase comprising a text description of the digital image with one or more masked tokens;
generating, utilizing a pretrained large language model, a teacher text embedding of the text description; and
modifying parameters of the vision-language model according to a masked distillation loss between the teacher text embedding and the text embedding generated by the text encoder.

2. The computer-implemented method of claim 1, further comprising modifying the parameters of the vision-language model according to an additional masked distillation loss between the image embedding generated by the vision encoder and a teacher image embedding generated by a pretrained vision foundation model.

3. The computer-implemented method of claim 2, wherein modifying the parameters of the vision-language model according to the additional masked distillation loss comprises distilling features learned by the pretrained vision foundation model into the vision encoder of the vision-language model to encourage the vision encoder to learn to replicate the teacher image embedding of the pretrained vision foundation model from the masked digital image.

4. The computer-implemented method of claim 1, wherein modifying the parameters of the vision-language model according to the masked distillation loss comprises distilling features learned by the pretrained large language model into the text encoder of the vision-language model to encourage the text encoder to learn to replicate the teacher text embedding of the pretrained large language model from the masked text phrase.

5. The computer-implemented method of claim 1, wherein:
extracting the text embedding comprises utilizing the text encoder of the vision-language model to project features from the unified embedding space of the vision encoder and the text encoder to a dimensionality of the pretrained large language model into; and
modifying the parameters of the vision-language model is based on projecting the features.

6. The computer-implemented method of claim 1, wherein:
extracting the image embedding comprises utilizing the vision encoder of the vision-language model to project features from the unified embedding space of the vision encoder and the text encoder to a dimensionality of a pretrained vision foundation model; and
modifying the parameters of the vision-language model is based on projecting the features.

7. The computer-implemented method of claim 1, further comprising modifying the parameters of the vision-language model to learn a projection from multilingual text embeddings of the pretrained large language model to text input embeddings of the text encoder.

8. A non-transitory computer readable medium storing executable instructions which, when executed by a processing device, cause the processing device to perform operations comprising:
generating, utilizing a vision encoder of a vision-language model, an image embedding in a unified embedding space of the vision-language model from a masked digital image comprising a digital image with one or more masked patches;
generating, utilizing a text encoder of the vision-language model and from a masked text phrase comprising a text description of the digital image with one or more masked tokens, a text embedding in the unified embedding space by projecting features from the unified embedding space to a dimensionality of a pretrained large language model; and
modifying parameters of the vision-language model based on projecting the features.

9. The non-transitory computer readable medium of claim 8, wherein the operations further comprise:
extracting the image embedding by utilizing the vision encoder of the vision-language model to project features from the unified embedding space to a dimensionality of a pretrained vision foundation model; and
modifying the parameters of the vision-language model based on projecting the features to the pretrained vision foundation model.

10. The non-transitory computer readable medium of claim 8, wherein the operations further comprise:
generating, utilizing the vision-language model to process the masked digital image and the masked text phrase, a predicted text embedding of the text description in a unified embedding space of the vision encoder and the text encoder; and
modifying the parameters of the vision-language model based on a masked distillation loss between the predicted text embedding and a teacher text embedding generated by the pretrained large language model.

11. The non-transitory computer readable medium of claim 8, wherein the operations further comprise:
generating, utilizing the vision-language model to process the masked digital image and the masked text phrase, a predicted image embedding of the digital image in a unified embedding space of the vision encoder and the text encoder; and
modifying the parameters of the vision-language model based on a masked distillation loss between the predicted image embedding and a teacher image embedding generated by a pretrained vision foundation model.

12. The non-transitory computer readable medium of claim 8, wherein the operations further comprise modifying the parameters of the vision-language model to learn, without inputting multilingual training data into the vision-language model, a projection from multilingual text embeddings of the pretrained large language model to text input embeddings of the text encoder.

13. The non-transitory computer readable medium of claim 8, wherein the operations further comprise:
generating, utilizing the vision-language model to process the masked digital image and the masked text phrase, a predicted text embedding of the text description of the digital image; and
modifying the parameters of the vision-language model using a contrastive loss to predict correctness of the predicted text embedding.

14. The non-transitory computer readable medium of claim 8, wherein the operations further comprise:
generating, utilizing the vision-language model to process the masked digital image and the masked text phrase, a predicted image embedding of the digital image; and
modifying the parameters of the vision-language model using a contrastive loss to predict correctness of the predicted image embedding.

15. A system comprising:
one or more memory devices; and
one or more processors coupled to the one or more memory devices, the one or more processors configured to cause the system to perform operations comprising:
processing a digital image utilizing a vision-language model comprising a vision encoder and a text encoder trained to project a lookup table of features from a dimensionality of a large language model trained on multilingual data into a unified embedding space of the vision encoder and the text encoder; and
generating, utilizing the vision-language model, a vision-language output by processing the digital image utilizing the lookup table projected by text encoder.

16. The system of claim 15, wherein the one or more processors are further configured to cause the system to generate the vision-language output by using the vision-language model to determine a classification of the digital image.

17. The system of claim 15, wherein the one or more processors are further configured to cause the system to generate the vision-language output by using the vision-language model to determine segmentations of objects depicted within the digital image.

18. The system of claim 15, wherein the one or more processors are further configured to cause the system to generate the vision-language output by using the vision-language model to generate a non-English caption for the digital image.

19. The system of claim 15, wherein the one or more processors are further configured to cause the system to generate the vision-language output by using the vision-language model to retrieve, from digital image database, one or more digital images corresponding to the digital image.

20. The system of claim 15, wherein the one or more processors are further configured to cause the system to generate an additional vision-language output by using the vision-language model to generate a caption that describes relational composition of objects depicted in the digital image.
